(19) United States
(12) Patent Application Publication
(10) Pub. No.: US 2008/0283165 A1
(43) Pub. Date: Nov. 20, 2008

(54) Pneumatic tire

(75) Inventors: Toshiyuki Mafune, Kobe-shi (JP); Hideo Nobuchika, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 12/073,321

(22) Filed: Mar. 4, 2008

(30) Foreign Application Priority Data
May 18, 2007 (JP) 2007-133196

(51) Int. Cl. B60C 19/08

(52) U.S. Cl. 152/152.1

(57) ABSTRACT

A pneumatic tire comprises a tread rubber comprising layers each formed by overlap winding a rubber tape. The rubber tape in each layer has a conductive part in the longitudinal direction of the tape and the remaining less-conductive part, wherein the conductive part is wound at least once around the tire. In the radially outermost layer, the conductive part is exposed in the tread surface by a total axial width WU of at least 1.0 mm. In the radially innermost layer, the conductive part appears in the radially inner surface so as to be electronically connected to a conductive underlying structure by a total axial width WL of at least 1.0 mm. Between the radially adjacent layers, the conductive part in the radially outer layer is connected to the conductive part in the radially inner layer by a total axial width WM of at least 1.0 mm. Preferably, the rubber tape is made of mainly a silica rich compound.

### BACKGROUND OF THE INVENTION

The present invention relates to a pneumatic tire, more particularly to a structure of the tread rubber composed of multiple windings of a rubber tape mainly made of a less-conductive rubber compound such as silica rich compound.

In recent years, there is a pressing need to reduce oil consumption by automobiles. Accordingly, it is a very important theme for tire manufactures to improve the rolling resistance of a pneumatic tire.

In order to improve the rolling resistance, the use of a silica-rich rubber compound as the tread rubber has been proposed. In the case of the silica-rich rubber compounds, however, the electric resistance of the vulcanized rubber becomes very high, and almost insulative. Therefore, in order to discharge static electricity to the ground through the tread portion, it is necessary to form a discharging path penetrating through the tread rubber.

On the other hand, in order to reduce the tire plant size and save the plant cost and also to achieve a flexible production, even in relatively small sized pneumatic tires for such as passenger cars and the like, there have been proposed a method for making a tread rubber by winding a rubber tape a number of times, for example as disclosed in the U.S. patent application publication No. US-2006-042733-A1.

In this proposition, as shown in FIG. 15, the tread rubber (a) is formed by winding a rubber tape (b) in a single layer, and a discharging path (e) is formed by a conductive film which is provided on at least one side of the tape so as to extend from the tread surface (as) to a conductive underlying structure (f).

In this structure, the windings of the rubber tape stand in the tire radial direction rather than lie in the tire axial direction. Accordingly, it is difficult to press the windings each other to make close contact. Therefore, there is a possibility that the adhesion between the windings becomes uneven though their joint surfaces are liable to be subjected to a large sharing force during cornering because the joint surfaces also stand in the tire radial direction. Further, (1) when winding the rubber tape, due to the difference between the diameter at the radially outer edge and the diameter at the radially inner edge of the wound tape, a large difference in the elongation is caused on the rubber tape, and the thickness is largely changed between the radially outside and inside of the tape. (2) If the axial position of the rubber tape is not well controlled during winding, the thickness in the radial direction is varied largely. Thus, it is difficult to obtain the desired cross sectional shape. (3) It is difficult to accurately apply the tape to the almost upright side face of the previously wound portion of the tape. This also makes it difficult to obtain the desired cross sectional shape.

### SUMMARY OF THE INVENTION

It is therefore, an object of the present invention to provide a pneumatic tire having a tread rubber composed of multiple windings of a rubber tape, in which

the adhesion between the windings is improved to increase the durability of the tread portion, and

during winding the rubber tape in a process of making the green tire, the desired cross sectional shape of the tread rubber can be obtained readily, while making a discharging path in the tread rubber at the same time.

According to the present invention, a pneumatic tire comprises a tread rubber disposed on a conductive underlying structure, wherein

the conductive underlying structure is electrically connected to a wheel rim when the tire is mounted on the wheel rim, and

the tread rubber comprises a plurality of layers including a radially innermost layer whose radially inner surface is electrically connected to the conductive underlying structure, and a radially outermost layer whose radially outer surface defines the tread surface,

the above-mentioned plurality of layers are each formed by overlap winding a rubber tape,

the rubber tape wound in each said layer has a conductive part in the longitudinal direction of the tape, and the remaining less-conductive part,

in each said layer, the conductive part is wound at least one time but preferably at most ten times around the tire,

in the radially outermost layer, the conductive part is exposed in the tread surface by a total axial width WU of at least 1.0 mm,

in the radially innermost layer, the conductive part appears in the radially inner surface so as to be electronically connected to the conductive underlying structure by a total axial width WL of at least 1.0 mm, and

between any of radially adjacent two layers of said plurality of layers, the conductive part in the radially outer layer is connected to the conductive part in the radially inner layer by a total axial width WM of at least 1.0 mm.

Therefore, as the thickness of the tread rubber is divided into a plurality of layers, the thickness of each layer decreases. As a result, the windings of the tape are largely leaned each against the adjacent one. Accordingly, in the process of making the green tire, it becomes easy to press the overlapped windings of the tape each other during winding the tape into the tread rubber, because the largely inclined windings can be pressed each other by applying a force in the tire radial direction, for example, using a pressure roller. Further, in the process of vulcanizing the green tire put in a mold, it can be avoided that the windings are separated and/or penetrated by protrusions formed on the inner surface of the mold to mold tread grooves in the tread surface of the tire. Rather, the protrusions press the windings each other. Accordingly, the bond strength between the windings and between the layers is uniformed and effectively improved. Thus, the tread durability can be effectively increased.

Further, in the process of winding the tape, the desired cross sectional shape for the windings as a whole can be easily obtained when compared with the above-mentioned prior art.

### BRIEF DESCRIPTION OF THE DRAWINGS

FIG. 1 is a cross sectional view of a pneumatic tire according to the present invention which is mounted on a standard wheel rim and inflated to a normal pressure.

FIGS. 2, 3 and 4 are perspective views each showing an example of the partially-conductive rubber tape used to make the tread rubber.

FIG. 5 is a schematic cross sectional view for explaining a way of winding the tread rubber.

FIG. 6 is a cross sectional view showing an example of the tread rubber, wherein the rubber tape shown in FIG. 2 is wound as shown in FIG. 5.

FIG. 7 is a partial enlarged cross sectional view of the tread rubber shown in FIG. 6 showing a discharging path penetrating through the tread rubber.

FIG. 8 is a partial enlarged cross sectional view of another example of the tread rubber, wherein the rubber tape shown in FIG. 3 or 4 is wound as shown in FIG. 5.

FIG. 9 is a schematic cross sectional view for explaining another way of winding the tread rubber.

FIG. 10 is a schematic plan view for explaining a method for making the rubber tape shown in FIG. 4.

FIG. 11 is a cross sectional view of an apparatus for making the rubber tape shown in FIG. 2.

FIGS. 12 and 13 are diagrams for explaining the operation of the selector valve thereof.

FIG. 14 is a diagram for explaining a method for measuring the electric resistance of a tire.

FIG. 15 is a cross sectional view of a prior art tread rubber.

### DESCRIPTION OF THE PREFERRED EMBODIMENTS

Embodiments of the present invention will now be described in detail in conjunction with accompanying drawings

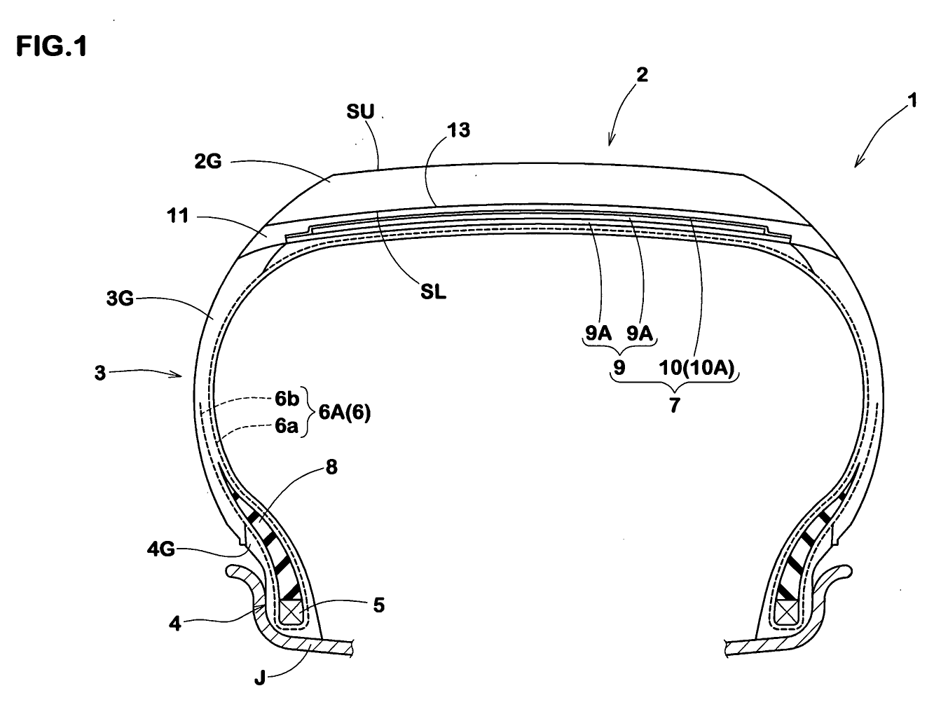

In the drawings, pneumatic tire 1 according to the present invention has a tread portion 2, a pair of sidewall portions 3 and a pair of axially spaced bead portions 3. As shown in FIG. 1, the tire 1 is provided with a bead core 5 disposed in each of the bead portions 4, a carcass 6 extending between the bead portions 4 through the tread portion 2 and sidewall portions 3, and a belt 7 disposed radially outside the carcass 6 in the tread portion 2. Although tread grooves are omitted in FIG. 1, the tread portion 2 is provided with tread grooves to form a tread pattern. The present invention is not limited to a specific tread pattern; therefore, various patterns can be provided.

The above-mentioned carcass 6 is composed of at least one ply 6A of rubberized cords arranged radially at an angle in the range of from 70 to 90 degrees with respect to the tire equator, extending between the bead portions 4 through the tread portion 2 and sidewall portions 3 and turned up around the bead core 5 in each bead portion 4 from the axially inside to the axially outside of the tire to form a pair of turnup portions 6b and a main portion 6a therebetween. In this embodiment, the carcass 6 is composed of a single ply 6A of cords arranged radially at an angle of 90 degrees with respect to the tire equator. Between the carcass ply main portion 6a and each turned up portion 6b, there is disposed a bead apex rubber 8 extending radially outwardly from the bead core 5.

The belt 7 is composed of a breaker 9 and/or a band 10. In this embodiment, the belt 7 includes both of the breaker 9 and band 10.

The breaker 9 is disposed on the crown portion of the carcass 6 across the substantially entire tread width, and composed of at least two cross plies 9A of rubberized high modulus parallel cords laid at an angle of from 15 to 40 degrees with respect to the tire circumferential direction. In this embodiment, the breaker 9 is composed of only the two cross plies 9A.

The band 10 is disposed on the breaker 9, and composed of spiral windings of at least one rubberized cord with a cord angle of not more than 5 degrees with respect to the tire circumferential direction. The band may be of an axially spaced two-piece structure wherein the two pieces cover the respective edge portions; or a one-piece structure wherein the one piece extends across the substantially overall width of the breaker; or a combination of the axially spaced two-pieces and the full-width piece. In this embodiment, a one-piece structure is employed.

In each of the sidewall portions 3, a sidewall rubber 3G is disposed axially outside the carcass 6.

In each of the bead portions 4, a clinch rubber 4G is disposed along the axially outer surface and bottom surface of the bead portion 4, covering at least a surface contacting with a wheel rim when the tire is mounted thereon. The radially outer end of the clinch rubber 4G is spliced with the radially inner end of the sidewall rubber 3G.

In the tread portion 2, a tread rubber 2G is disposed radially outside the belt 7. The tread rubber 2G can be disposed directly on the radially outside of the belt 7. In this embodiment, however, a conductive rubber under layer 11 is disposed on the radially outside of the belt 7, and then the tread rubber 2G is disposed on the conductive rubber under layer 11. The conductive rubber under layer 11 is, at the axial ends, connected to the radially outer ends of the sidewall rubbers 3G. The conductive rubber under layer 11 in this example is formed by overlap winding a rubber tape made of a conductive rubber compound only. The conductive rubber under layer 11, sidewall rubber 3G and clinch rubber 4G are carbon rich compounds containing carbon black and having a volume resistivity of less than 1.0×10̂8 (ohm cm), preferably less than 1.0×107 (ohm cm) after vulcanized. The topping rubber of the carcass cords and the topping rubber of the belt (breaker and band) cords are also carbon rich compounds containing carbon black and having a volume resistivity of less than 1.0×10̂8 (ohm cm), preferably less than 1.0×107 (ohm cm) after vulcanized.

Here, the volume resistivity is measured with a ohm meter (ADVANTESTER 8340A), using a specimen of 15 cm×15 cm×2 mm, under the following conditions: applied voltage 500 v, temperature 25deg. C., and relative humidity 50%.

Therefore, a conductive path being continuous from the radially outer surface 13 of the conductive rubber under layer 11 to the outer surface of the clinch rubber 4G through the sidewall rubber 3G, belt topping rubber and carcass topping rubber, is formed.

In this embodiment, therefore, the radially outer surface 13 forms the undertread junction face 13 to which the conductive rubber of the tread rubber 2G is connected.

If the conductive rubber under layer 11 is omitted, the radially outer surface of the belt forms the undertread junction face 13. Incidentally, when the sidewall rubber 3G and clinch rubber 4G are conductive, the topping rubber of the belt 7 and/or that of the carcass 6 may be less- or non-conductive.

When the topping rubber of the belt 7 and that of the carcass 6 are conductive, the sidewall rubber 3G may be less- or non-conductive.

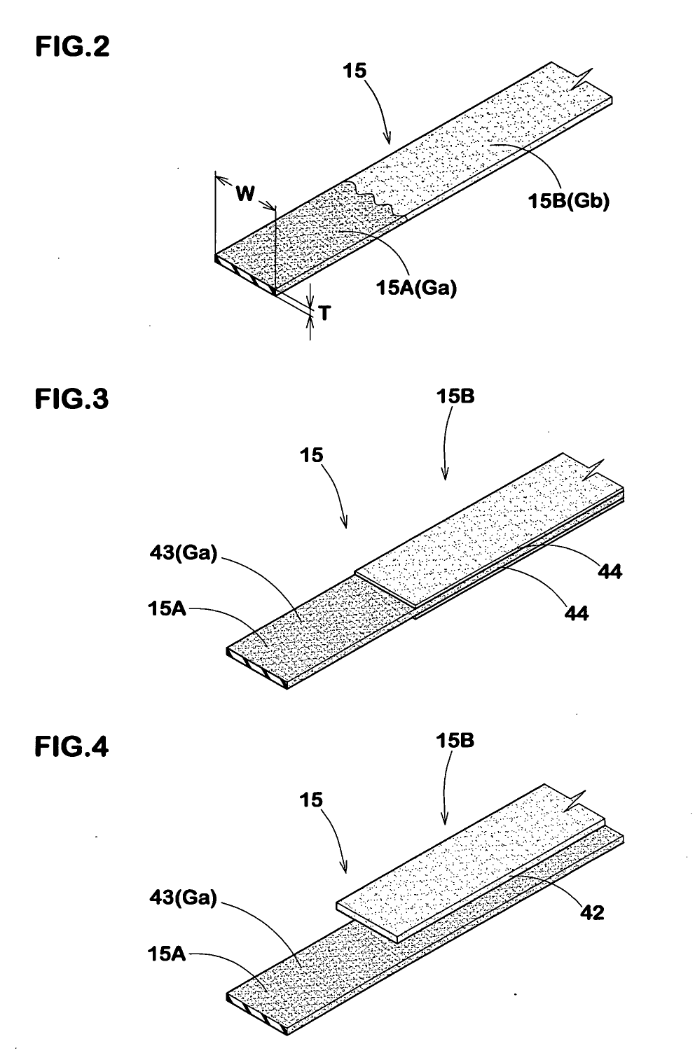

According to the present invention, the tread rubber 2G is composed of a large number of windings of a partially-conductive rubber tape 15 as shown in FIGS. 2, 3 and 4. The tread rubber 2G is formed by overlap-winding a raw rubber tape 15 a number of times.

The raw rubber tape 15 is made from mainly a less-conductive rubber compound Ga. In other words, the less-conductive rubber compound Ga forms the almost entire part 15A of the tape 15 (hereinafter the “less-conductive rubber part 15A“). And partly of the longitudinal direction of the tape, a conductive rubber part 15B is formed by a conductive rubber compound Gb or a conductive coating 44.

In the example shown in FIG. 2, the conductive rubber part 15B forms the entire thickness T of the tape 15. Accordingly, the less-conductive rubber part 15A is discontinuous.

In the example shown in FIG. 3, the less-conductive rubber part 15A is continuous along the entire length. The conductive rubber part 15B is formed on each side of the tape 15 as a thinner surface layer.

In the example shown in FIG. 4, the less-conductive rubber part 15A is also continuous along the entire length. The conductive rubber part 15B is formed on one side of the tape 15 by overlapping a tape of the conductive rubber compound Gb and a tape of the less-conductive rubber part 15A in an off-center manner.

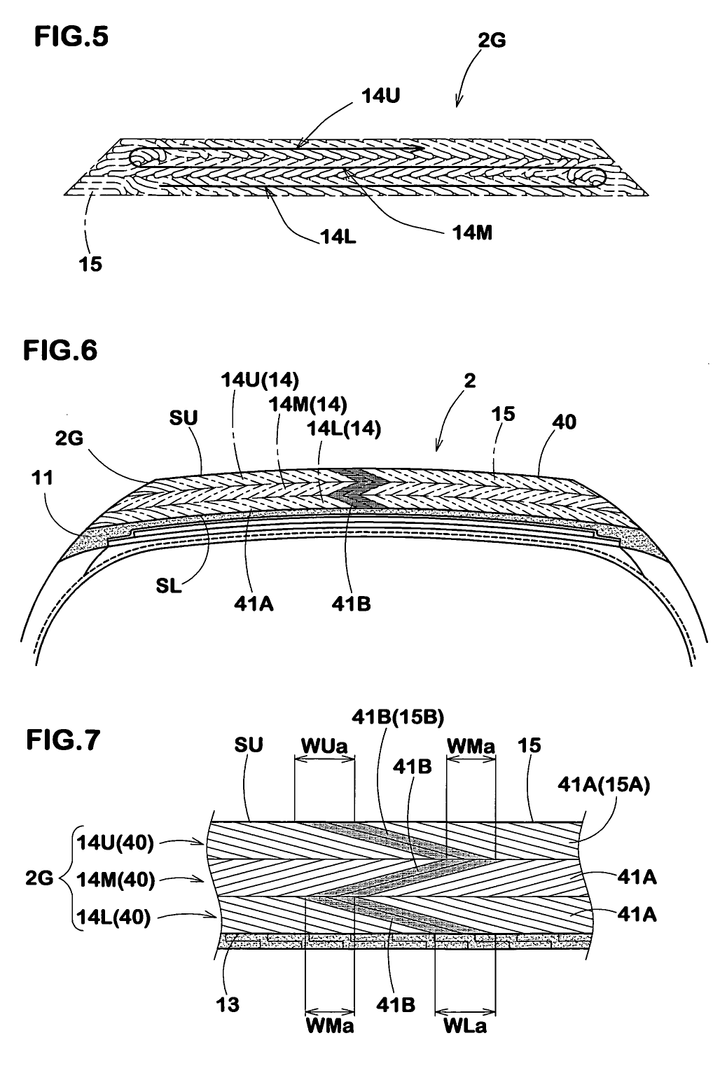

FIG. 5 shows a way of overlap-winding the raw rubber tape 15. In this example, a first layer 14L is formed by winding the tape, starting from one end (on the left side of FIG. 5) of the tread rubber 2G, to the other end. Then, a second layer 14M is formed on the first layer by winding the same tape continuously from the other end to the one end. Further, a third layer 14U is formed on the second layer by winding the same continuously from the one end to the other end. Thus, in this case, the inclining directions of windings become alternate.

In order to reduce the time to complete the tread rubber 2G, as shown in FIG. 9, a plurality of raw rubber tapes 15 can be wound almost simultaneously from the one end to the other end, with the winding start time delaying from the first layer to the third layer in small steps. In this case, the inclining directions of windings become one direction.

In any case, the tread rubber 2G has at least two layers 14L and 14U, preferably at least three layers 14L, 14M and 14U, each layer is made up of overlapped windings 40 of the partially-conductive rubber tape 15.

The reasons for such a multi-layered structure are as follows. As the number of layers 14 increases, the individual thickness decreases. Accordingly, in each layer 14, the windings are inclined largely with respect to the tire radial direction. During winding the tape as well as vulcanizing the tire in a mold, therefore, the windings can be pressed in the radial direction so as to make close contact with each other. As a result, the adhesion between the windings can be improved. Further, owing to the large inclination angle, the resistance to local separation between windings (look like cracks) caused by a large lateral force allied to the tread portion during cornering, can be improved. Thus, the durability of the tread portion can be improved. These are especially important when the silica rich tread compound is used in the tape winding method.

When the raw rubber tape 15 shown in FIG. 2 is wound as shown in FIG. 5, the tread rubber 2G is provided with a structure shown in FIGS. 6 and 7. In this case, all of the layers 14 (14L, 14M and 14U) each have a conductive zone 41B formed from windings made of the conductive part 15B only, and the remaining part 41A of each layer 14 is formed from windings made of the less-conductive part 15A only.

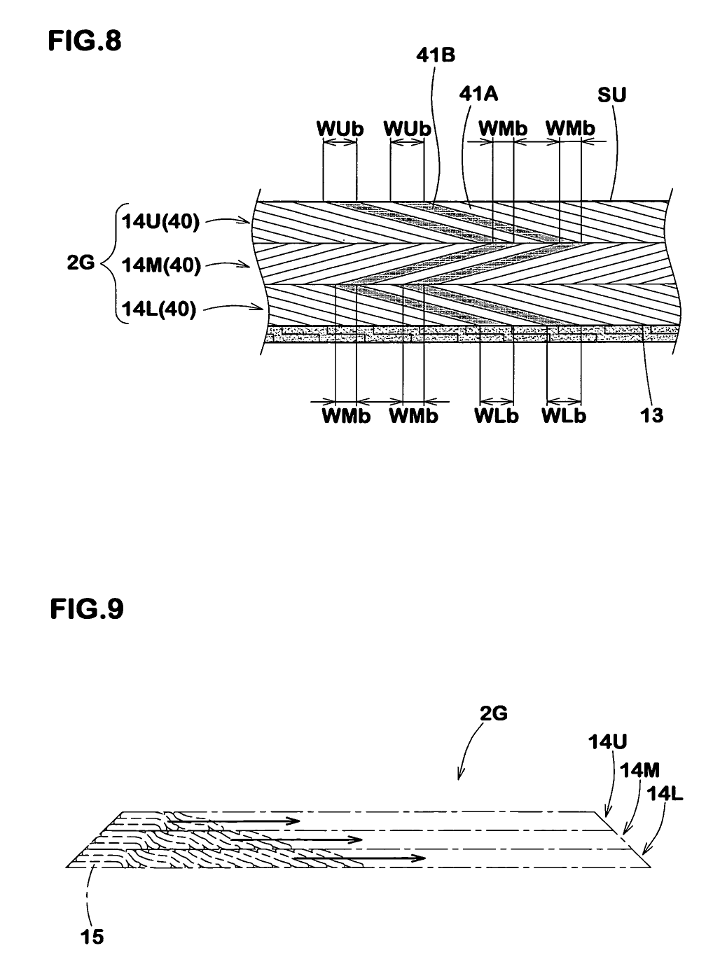

When the raw rubber tape 15 shown in FIG. 3 or FIG. 4 is wound as shown in FIG. 5, the tread rubber 2G is provided with a structure shown in FIG. 8. In this case, all of the layers 14 (14L, 14M and 14U) each have conductive zones 41B formed from the conductive part 15B of the windings, and the remaining part 41A of each layer 14 is formed from windings made of the less-conductive part 15A only.

The difference from the above example is that the thin less-conductive part 15A is interposed between the conductive zones 41B.

In any case, the conductive zones 41B of all the layers 14 have to be formed at almost same axial positions so as to electrically continue from the outer surface SU (namely tread surface) to the inner surface SL of the tread rubber 2G. Since the inner surface SL contact with the above-mentioned undertread junction face 13, a discharge path extending from the tread surface to the bead surface is formed.

Therefore, between the radially adjacent layers 14, it is necessary that the radially inner and outer conductive zones 41B contact with each other by a total axial width WM (WMa in FIG. 7, WMb+WMb in FIG. 8) of not less than 1.0 mm.

In the tread surface SU, it is necessary that the conductive zone(s) 41B of the radially outermost layer 14U is exposed by a total axial width WU (WUa in FIG. 7, WUb+WUb in FIG. 8) of not less than 1.0 mm.

In the inner surface SL, it is necessary that the conductive zone(s) 41B of the radially innermost layer 14L contacts with the undertread junction face 13 by a total axial width WL (WLa in FIG. 7, WLb+WLb in FIG. 8) of not less than 1.0 mm.

Preferably, the total axial widths WU, WL and WM are not less than 3.0 mm, more preferably not less than 5.0 mm. However, if too large, the uneven wear resistance of the tread rubber, tire running performance and the like are liable to deteriorate. Therefore the total axial widths WU, WL and WM are not more than 10.0 mm, preferably not more than 7.0 mm.

In order to ensure the electrical continuity from the outer surface SU to the inner surface SL of the tread rubber 2G, it is preferred that the number of windings of a longitudinal portion of the tape 15 which portion has the conductive part 15B is in a range of from 1 to 10. Preferably, the number of windings is set to be not more than 5 as far as the above-mentioned preferable widths WU, WL and WM can be secured.

As to the cross sectional shape of the raw rubber tape 15, on the other hand, various shapes can be employed. In addition to the flat rectangle or similar, for example, shapes whose both sides are tapered such as parallelogram and trapezoid can be preferably employed to secure the widths WU, WL and WM and to prevent air entrapment.

The above-mentioned less-conductive rubber compound Ga in this embodiment is a silica rich compound comprising 30 to 100 parts by mass of silica as a reinforcing filler, and 100 parts by mass of base rubber.

The base rubber comprises one or more kinds of diene rubbers, e.g. natural rubber (NR), butadiene rubber (BR), emulsion styrene butadiene rubber (E-SBR), solution styrene butadiene rubber (S-SBR), polyisoprene rubber (IR), nitrile rubber (NBR), chloroprene rubber (CR) and the like.

In view of the rolling resistance and wet grip, it is preferable that the silica is not less than 40 parts by mass, but not more than 80 parts by mass, more preferably not more than 60 parts by mass.

In view of the reinforcing effect and the processability of the rubber compound, it is preferable for the silica that: the BET surface area determined from nitrogen adsorption is in a range of from 150 to 250 sq.m/g; and the dibutyl phthalate (DBP) oil absorption is not less than 180 ml/100 g; and further it show colloidal characteristic.

As to silane coupling agent, vis(triethoxysilylpropyl)tetrasulfide, alpha-mercaptpropyltrimethoxysilane or the like can be preferably used.

In addition to the silica, carbon black may be added as auxiliary reinforcing filler to control the elastomeric properties, e.g. elastic modulus, hardness and the like. In this case, the carbon black content is less than that of the silica, preferably not more than 15 parts by mass, more preferably not more than 10 parts by mass with respect to 100 parts by mass of the base rubber. If the carbon black content is more than 15 parts by mass, the lowering of the rolling resistance by the silica is impeded, and there is a tendency that the hardness becomes undesirably high.

According to the present invention, it is not always necessary to use the same less-conductive rubber compound Ga in all of the layers 14. Different less-conductive rubber compounds Ga can be used.

The conductive rubber compound Gb in this embodiment is a carbon rich compound comprising 30 to 100 parts by mass of carbon black, and 100 parts by mass of base rubber.

The base rubber comprises one or more kinds of diene rubbers, e.g. natural rubber (NR), butadiene rubber (BR), emulsion styrene butadiene rubber (E-SBR), solution styrene butadiene rubber (S-SBR), polyisoprene rubber (IR), nitrile rubber (NBR), chloroprene rubber (CR) and the like.

As to the carbon black, HAF and/or ISAF whose BET surface area determined from nitrogen adsorption is not less than 70 sq.m/g can be preferably used.

According to the present invention, it is not always necessary to use the same conductive rubber compound Gb in all of the layers 14. As far as the volume resistivity is in the above-mentioned range, different conductive rubber compounds Gb can be used.

Incidentally, in the less-conductive rubber compound Ga and conductive rubber compound Gb, various additives such as vulcanizing agent, age resistor, vulcanization accelerator, auxiliary vulcanization accelerator, vulcanization retarder, plasticizer and the like may be added according to need.

The above-mentioned conductive coating 44 can be formed by applying a liquid conducting agent to both sides of a tape 43 of the less-conductive rubber compound Ga.

The liquid conducting agent can be a solution of a conducting material dissolved in a solvent, or a colloidal suspension of a conducting material dispersed in a carrier fluid.

As to the conducting material, carbon black and metal powder are suitably used. As to the carrier fluid, organic solvents such as toluene and hexane are preferably used, but water can be used too.

Further, in order that to increase the thickness of the conductive coating 44 by increasing the degree of viscosity and also to increase the bonding strength between the conducting material and the tape 43, a latex or similar in which the conducting material is dispersed together with rubber polymer in an aqueous medium or an organic solvent, can be used as the liquid conducting agent. In this case, the rubber polymer of the same kind as the tape 43 (in this embodiment diene rubber) is preferably used in view of the adhesive strength.

Such a liquid conducting agent can be applied during winding the tape 15, by a simple way such as dipping, pouring, spraying and brush applying. Thus, the conductive coating 44 can be easily formed.

In any way, the conductive coating 44 forms the conductive part 15B, and the non-coated part forms the less-conductive part 15A.

In the case of the partially-conductive rubber tape 15 shown in FIG. 3, the conductive part 15B on each side of the tape can be formed by the conductive coating 44. Further, it is also possible to form the conductive part 15B by applying or overlapping a thinner tape of the conductive rubber compound Gb on the thicker base tape 43 made of the less-conductive rubber compound Ga.

In the case of the partially-conductive rubber tape 15 shown in FIG. 4, the conductive part 15B is also formed by overlapping a tape 42 of the conductive rubber compound Gb. In this case, however, in order to use the tape 42 as thick as the base tape 43 made of the less-conductive rubber compound Ga, the conductive rubber part 15B is formed on one side of the tape 15 by overlapping the tape 42 and tape 43 in an off-center manner.

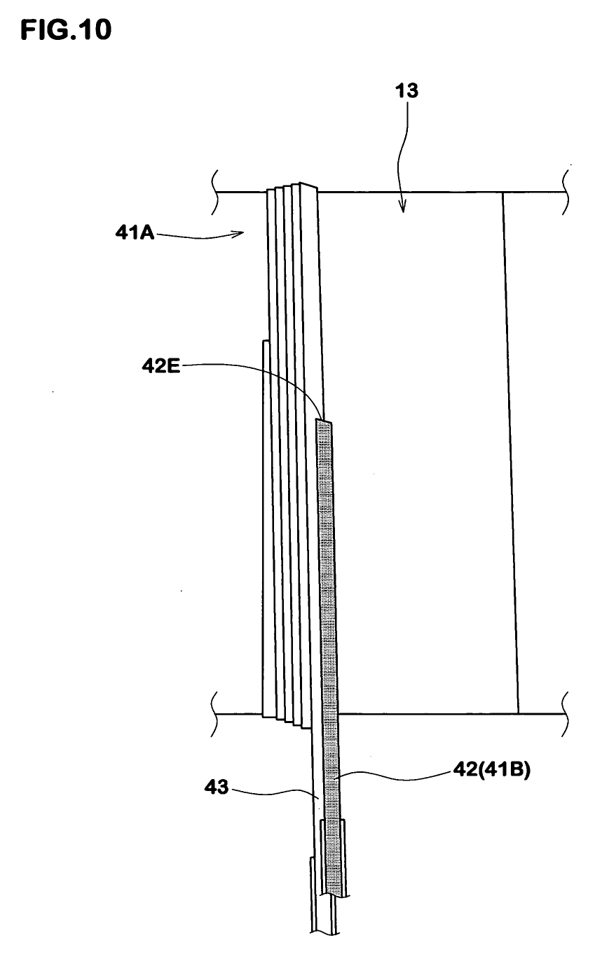

FIG. 10 shows a way of overlapping the conductive rubber compound tape 42 and the less-conductive rubber compound tape 43, wherein during winding the less-conductive-rubber tape 43 as the less-conductive part 15A of the tape 15, when the windings reach to the predetermined axial position, the end 42E of the conductive-rubber tape 42 is attached to the tape 43. Thus, the overlapped tapes 42 and 43 are wound as the partially-conductive rubber tape 15. After wound several times, the tape 42 is cut, then, again the tape 43 alone is wound. At the time of attaching the end 42e and cutting the tape 42, it is not necessary to stop the winding of the tape 43.

In the case of the partially-conductive rubber tape 15 shown in FIG. 2, as the conductive part 15B is completely interposed between the less-conductive parts 15A in the tape longitudinal direction, it is desirable to extrude the tape 15 from a single nozzle, by switching between the less-conductive rubber compound Ga and conductive rubber compound Gb, so as to have a constant cross sectional shape along the length.

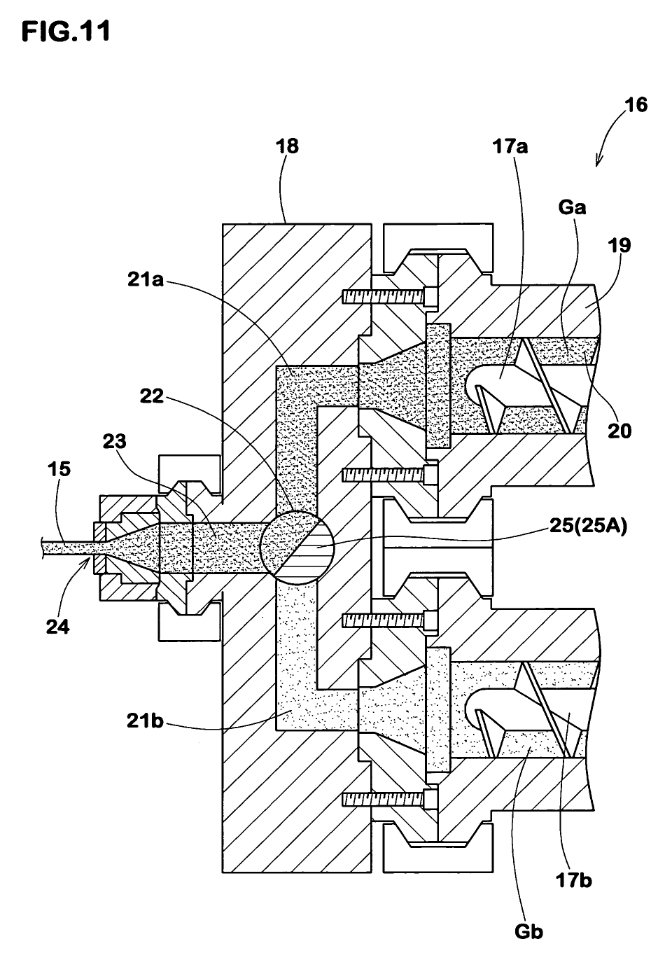

FIG. 11 shows an extruder 16 to produce this type of rubber tape 15.

The extruder 16 comprises: a screw 17a for the less-conductive rubber compound Ga; a screw 17b for the conductive rubber compound Gb; a selector valve 25 to switch between the compounds Ga and Gb; and a single nozzle 24 from which the compound Ga or Gb selected by the valve 25 is extruded.

The screw 17a or 17b is disposed in a cylindrical bore 20 of a main body 19 of the extruder 16. By rotating the screw, the plasticized rubber compound Ga or Gb is pushed out from the outlet of the main body 19 formed at the front end.

The two outlets are connected to two passages 21a and 21b, respectively, formed in a single head block 18 to which the front end of each main body 19 is fixed.

The two passages 21a and 21b extend to the nozzle 24 through a switching room 22 to which the passages 21a and 21b are connected, and a downstream passage 23 extending from the switching room 22 to the nozzle 24.

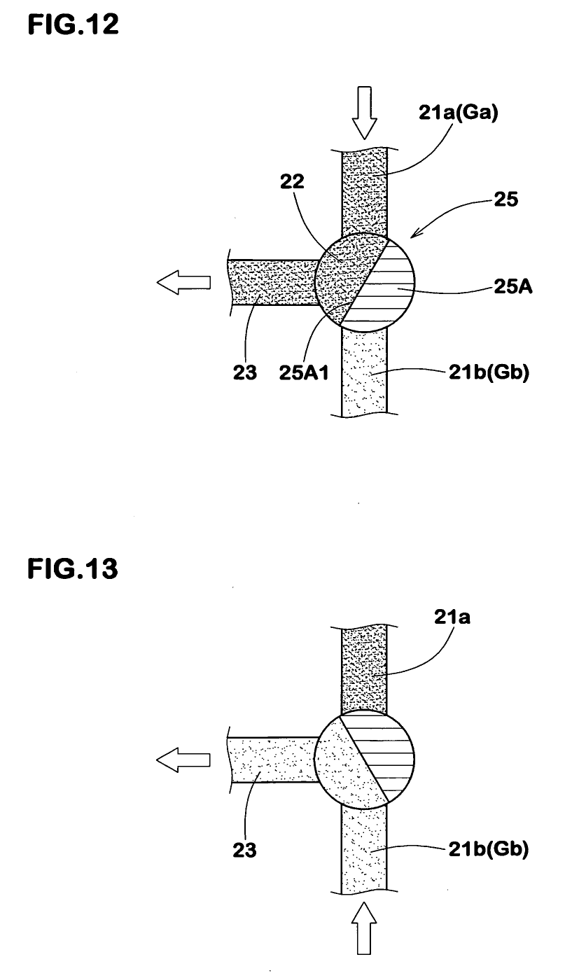

In the switching room 22, there is provided the selector valve 25 to connect the downstream passage 23 to the passage 21a or the passage 21b selectively as shown in FIGS. 12 and 13.

Accordingly, the rubber compound Ga or Gb is continuously extruded from the nozzle 24, and the continuous rubber tape 15 shown in FIG. 2 is formed.

The selector valve 25 in this example is a ball valve 25A disposed in the round switching room 22. The ball valve 25A is provided with a cut off part 25A1. By rotating the ball valve 25A, the passage 23 can be connected to one of the passage 21a and passage 21b through the cut off part 25A1.

In this embodiment, during one of the rubber compounds is extruded from the nozzle 24, the screw for the other rubber compound is stopped in order to prevent the pressure of the other rubber compound from becoming excessively high.

However, it is desirable to rotate both of the screws continuously by retuning the other rubber compound to the inlet through a return passage provided for each screw.

### Comparison Tests

Pneumatic tires of size 215/45ZR17 (wheel rim size:17×7J) for passenger car were experimentally manufactured and tested for the rolling resistance, and the electric resistance of the tire was measured.

Except for the items shown in Table 1, all of the tires had the same structure as shown in FIG. 1.

In each tire, the conductive rubber under layer 11, topping rubber of the belt, sidewall rubber and clinch rubber had volume resistivities of about 1×10̂5 (ohm cm), and good conductivity was secured between the radially outer surface 13 of the conductive rubber under layer 11 and the axially outer surface and bottom surface of the bead portions.

The conductive rubber under layer 11 was formed by overlap winding a tape of the conductive rubber compound.

In Ex. 1-Ex. 7: The tread rubbers were formed by overlap winding the partially-conductive rubber tapes shown in Table 1.

In Ref. 1: The tread rubber was formed by overlap winding a conductive-rubber tape made of only the rubber compound B.

In Ref. 2: The tread rubber was formed by overlap winding a less-conductive-rubber tape made of only the rubber compound A.

Rolling Resistance Test:

using a rolling resistance tester, the rolling resistance was measured at a speed of 80 km/h, a tire load of 5.9 kN, and a tire pressure of 200 kPa. The results are shown in Table 1 by an index based on Ref. 1 being 100 wherein the larger the value, the smaller the rolling resistance.

Electric Resistance Test:

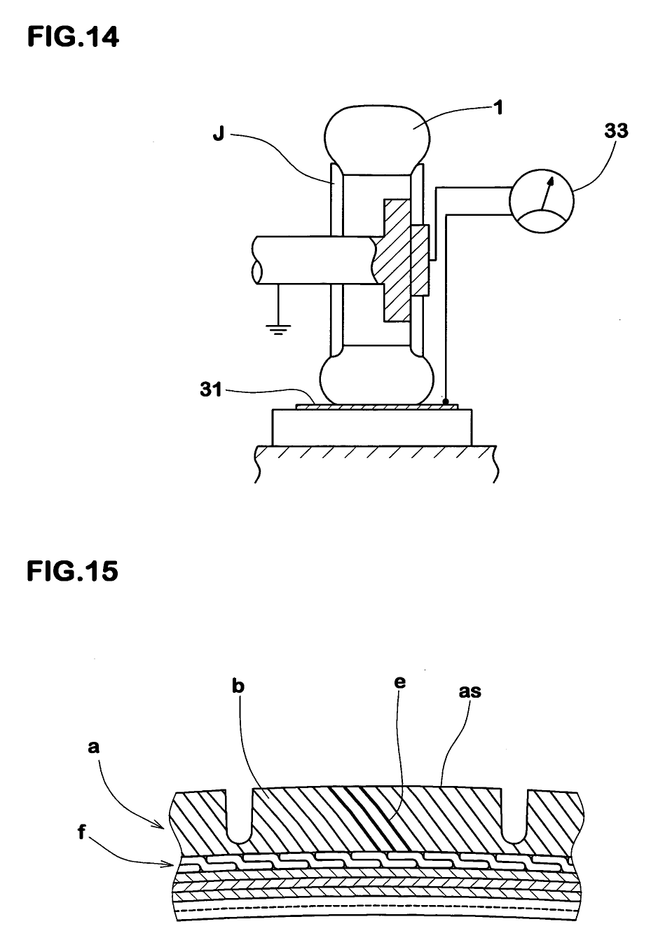

As shown in FIG. 14, according to the procedure specified by JATMA, each test tire mounted on an aluminum alloy wheel rim J and inflated to 200 kPa was placed on a metal plate 31 with a tire load of 5.9 kN, and the electric resistance between the metal plate 31 and the wheel rim J was measured with a resistance meter 33 at an environmental temperature of 25deg. C. and 50_% relative humidity. The applied voltage was 1000 V.

TABLE 1

| Tire | Ref. 1 | Ref. 2 | Ex. 1 | Ex. 2 | Ex. 3 | Ex. 4 | Ex. 5 | Ex. 6 | Ex. 7 |
|---|---|---|---|---|---|---|---|---|---|
| Rubber tape | — | — | FIG. 3* | FIG. 3* | FIG. 2 | FIG. 2 | FIG. 4 | FIG. 4 | FIG. 2 |
| Tread rubber | | | | | | | | | |
| Number of layers | 3 | 3 | 3 | 3 | 3 | 3 | 3 | 3 | 3 |
| Winding | FIG. 5 | FIG. 5 | FIG. 5 | FIG. 5 | FIG. 5 | FIG. 5 | FIG. 5 | FIG. 5 | FIG. 5 |
| Less-conductive parts 41A | non | | | | | | | | |
| Rubber composition | — | A | A | A | A | A | A | A | A |
| Conductive zones 41B | | non | | | | | | | |
| Rubber composition | B | — | B | B | B | B | B | B | B |
| Width WU (mm) | — | — | 1.0 | 3.0 | 1.0 | 3.0 | 1.0 | 3.0 | 3.0 |
| Width WM (mm) | — | — | 1.0 | 3.0 | 1.0 | 3.0 | 1.0 | 3.0 | 2.0 |
| Width WL (mm) | — | — | 1.0 | 3.0 | 1.0 | 3.0 | 1.0 | 3.0 | 2.0 |
| Test results | | | | | | | | | |
| Rolling resistance | 100 | 120 | 119 | 115 | 115 | 112 | 114 | 112 | 113 |
| Electric resistance (10\hat{ }8 ohm) | 0.4 | 2.7 | 0.6 | 0.4 | 0.4 | 0.05 | 0.7 | 0.4 | 0.1 |

*The tape 15 was provided with the conductive coating 44 by applying a solution of the rubber compound (A) dissolved in an organic solvent.

TABLE 2

| Rubber composition | A | B |
|---|---|---|
| Base rubber | | |
| SBR | 80 | 80 |
| BR | 20 | 20 |
| Silica | 50 | 10 |
| Carbon black | 10 | 50 |
| Zinc oxide | 3 | 3 |
| Stearic acid | 2 | 2 |
| Age resistor | 2 | 2 |
| Aroma oil | 20 | 20 |
| Sulfur | 1.5 | 1.5 |
| Volume resistivity (ohm cm) | 1 × 10\hat{ }8 | 1 × 10\hat{ }5 |

1. A pneumatic tire comprising
a tread rubber disposed on a conductive underlying structure, the conductive underlying structure electrically connected to a wheel rim when the tire is mounted on the wheel rim,
the tread rubber comprising a plurality of layers including a radially innermost layer whose radially inner surface is electrically connected to the conductive underlying structure, and a radially outermost layer whose radially outer surface defines the tread surface,
said plurality of layers each formed by overlap winding a rubber tape,
wherein
the rubber tape wound in each said layer has a conductive part in the longitudinal direction of the tape, and the remaining less-conductive part,
in each said layer, the conductive part is wound at least once around the tire,
in the radially outermost layer, the conductive part is exposed in the tread surface by a total axial width WU of at least 1.0 mm,
in the radially innermost layer, the conductive part appears in the radially inner surface so as to be electronically connected to the conductive underlying structure by a total axial width WL of at least 1.0 mm, and
between any of radially adjacent two layers of said plurality of layers, the conductive part in the radially outer layer is connected to the conductive part in the radially inner layer by a total axial width WM of at least 1.0 mm.

2. The pneumatic tire according to claim 1, wherein
in the cross section of the tire including the tire rotational axis, the conductive part in at least one of said plurality of layers forms a conductive zone being continuous in the ti re axial direction.

3. The pneumatic tire according to claim 1, wherein
in the cross section of the tire including the tire rotational axis, the conductive part in at least one of said plurality of layers forms conductive zones alternating with less-conductive zones in the tire axial direction, wherein the less-conductive zones are formed by said remaining less-conductive part.

4. The pneumatic tire according to claim 1, wherein
said total axial widths WU, WL and WM are not less than 3.0 mm.

5. The pneumatic tire according to claim 1, wherein
said conductive underlying structure is a tread reinforcing belt.

6. The pneumatic tire according to claim 1, wherein
said conductive underlying structure is a layer made of a conductive rubber disposed on a tread reinforcing belt.

7. The pneumatic tire according to claim 1, wherein
said conductive underlying structure is a conductive rubber layer formed by overlap winding a conductive rubber tape on a tread reinforcing belt.

8. The pneumatic tire according to claim 1, wherein
the less-conductive parts wound in the respective layers are made from same rubber compounds.

9. The pneumatic tire according to claim 1, wherein
the less-conductive parts wound in the respective layers are made from at least two different rubber compounds.

10. The pneumatic tire according to claim 1, wherein
the less-conductive parts wound in the respective layers are made from rubber compounds containing silica and optionally carbon black less than the silica.
